(19) United States
(12) Patent Application Publication
(10) Pub. No.: US 2025/0205605 A1
(43) Pub. Date: Jun. 26, 2025

(54) PROGRAM, VIRTUAL SPACE PROVIDING METHOD, AND VIRTUAL SPACE PROVIDING SYSTEM

(71) Applicant: Cover Corp., Tokyo (JP)

(72) Inventor: Kouhei MORI, Tokyo (JP)

(21) Appl. No.: 18/846,699

(22) PCT Filed: Aug. 9, 2022
(86) PCT No.: PCT/JP2022/030419

§ 371 Date: Sep. 13, 2024

(30) Foreign Application Priority Data
Mar. 16, 2022 (JP) 2022-041413

(51) Int. Cl. A63F 13/63; A63F 13/52; A63F 13/533; A63F 13/55; G06T 19/20

(52) U.S. Cl. CPC A63F 13/63; A63F 13/52; A63F 13/533; A63F 13/55; G06T 19/20; G06T 2219/2004

(57) ABSTRACT

A program is provided for causing a computer providing a virtual space (VS) to function as: an acquiring unit that acquires item information regarding a plurality of items used by an object (O) operated by a user in the virtual space (VS); a formation unit that forms one or more virtual structures based on the plurality of items; a selecting unit that selects items of a common variation VR associated with the plurality of items, based on a user input; and a replacement unit that replaces at least a portion of the plurality of items forming the one or more virtual structures with items of the common variation VR, when the plurality of items satisfy a predetermined condition. This program provides an information processing technique that improves users' convenience regarding their operation on virtual structures in a virtual space.

### TECHNICAL FIELD

The present invention relates to a program, a method for providing a virtual space, and a system for providing a virtual space.

### BACKGROUND ART

Patent Document 1 describes an information processing apparatus that executes a building game. The document discloses that, in this information processing apparatus, a building that a user wishes to build in a game is customized, etc. in advance so that the user can quickly build a desired building in the game.

### CITATION LIST

### Patent Document

Patent Document 1: JP2020-507362 A

### SUMMARY

### Technical Problem

According to conventional game systems, such as the one described in Patent Document 1, users can quickly build a desired building as mentioned above. However, when a user wishes to change components of a particular building in the conventional game systems, such user needs to individually specify each component to be changed and then change the specified component. As such, changing components is a complex and burdensome process for users.

Some aspects of the present invention have been made in view of the above-described circumstances, and an object thereof is to provide an information processing technique that improves users' convenience regarding their operation on virtual structures in a virtual space.

### Solution to Problem

A program according to an aspect of the present invention causes a computer providing a virtual space to function as: an acquiring unit that acquires item information regarding a plurality of items used by an object operated by a user in the virtual space; a formation unit that forms one or more virtual structures based on the plurality of items; a selecting unit that selects items of a common variation associated with the plurality of items, based on a user input; and a replacement unit that replaces at least a portion of the plurality of items forming the one or more virtual structures with items of the common variation, when the plurality of items satisfy a predetermined condition.

A method for providing a virtual space according to an aspect of the present invention includes the steps of: acquiring item information regarding a plurality of items used by an object operated by a user in the virtual space; forming one or more virtual structures based on the plurality of items; selecting items of a common variation associated with the plurality of items, based on a user input; and replacing at least a portion of the plurality of items forming the one or more virtual structures with items of the common variation, when the plurality of items satisfy a predetermined condition.

A system for providing a virtual space according to an aspect of the present invention includes: an acquiring unit that acquires item information regarding a plurality of items used by an object operated by a user in the virtual space; a formation unit that forms one or more virtual structures based on the plurality of items; a selecting unit that selects items of a common variation associated with the plurality of items, based on a user input; and a replacement unit that replaces at least a portion of the plurality of items forming the one or more virtual structures with items of the common variation, when the plurality of items satisfy a predetermined condition.

In the present invention, a “unit” does not merely refer to a physical means alone, and the functions of a “unit” may be realized through software. In addition, the functions of a single “unit” or a single device may be realized by two or more physical means or devices, and the functions of two or more “units” or devices may be realized by a single physical means or device.

### Advantageous Effects of Invention

The present invention improves users' convenience regarding their operation on virtual structures in a virtual space.

### BRIEF DESCRIPTION OF DRAWINGS

FIG. 1 is a schematic configuration diagram (system configuration diagram) of an information processing system according to a first embodiment of the present invention.

FIG. 2 is an overview illustrating an example of a crafting game according to the first embodiment of the present invention.

FIG. 3 is a schematic configuration diagram (block diagram) showing an example of the functional configuration of an information processing server and a player terminal according to the first embodiment of the present invention.

FIG. 4 is a diagram showing an example of item information according to the first embodiment of the present invention.

FIG. 5 is an illustration for explaining an example of a virtual warehouse according to the first embodiment of the present invention.

FIG. 6 is an illustration showing an example of a protect cube (PQ) according to the first embodiment of the present invention.

FIG. 7 is an illustration showing an example PQ according to the first embodiment of the present invention.

FIG. 8 is an illustration showing an example PQ according to the first embodiment of the present invention.

FIG. 9 is a flowchart showing an example of craft processing according to the first embodiment of the present invention.

FIG. 10 is an illustration showing an example of a screen of an output unit of the player terminal according to the first embodiment of the present invention.

FIG. 11 is an illustration showing an example of a screen of an output unit of the player terminal according to the first embodiment of the present invention.

FIG. 12 is an illustration showing an example of a screen of an output unit of the player terminal according to the first embodiment of the present invention.

FIG. 13 is a flowchart showing an example of virtual structure change processing according to the first embodiment of the present invention.

FIG. 14 is an illustration showing an example of a screen of an output unit of the player terminal according to the first embodiment of the present invention.

FIG. 15 is an illustration showing an example of a screen of an output unit of the player terminal according to the first embodiment of the present invention.

FIG. 16 is an illustration showing an example of a screen of an output unit of the player terminal according to the first embodiment of the present invention.

FIG. 17 is a flowchart showing an example of virtual structure movement processing according to the first embodiment of the present invention.

FIG. 18 is an illustration showing an example of a screen of an output unit of the player terminal according to the first embodiment of the present invention.

FIG. 19 is a conceptual diagram showing an example of virtual structure placement processing according to the first embodiment of the present invention.

FIG. 20 is a schematic configuration diagram showing an example of the functional configuration of an information processing server and a player terminal according to a second embodiment of the present invention.

FIG. 21 is a schematic configuration diagram showing an example of the functional configuration of an information processing server and a player terminal according to a third embodiment of the present invention.

FIG. 22 is a schematic configuration diagram (block diagram) of an information processing server and a player terminal according to each embodiment of the present invention.

### DESCRIPTION OF EMBODIMENTS

Hereinafter, embodiments of the present invention will be described with reference to the accompanying drawings. The embodiments set forth below are presented by way of example only for describing the invention, and are not intended to limit the present invention to the described embodiments only. Furthermore, the present invention can be modified in various ways without departing from the spirit of the invention. In each of the drawings, the same components are denoted by the same reference numerals wherever possible, and redundant explanations are omitted.

### First Embodiment

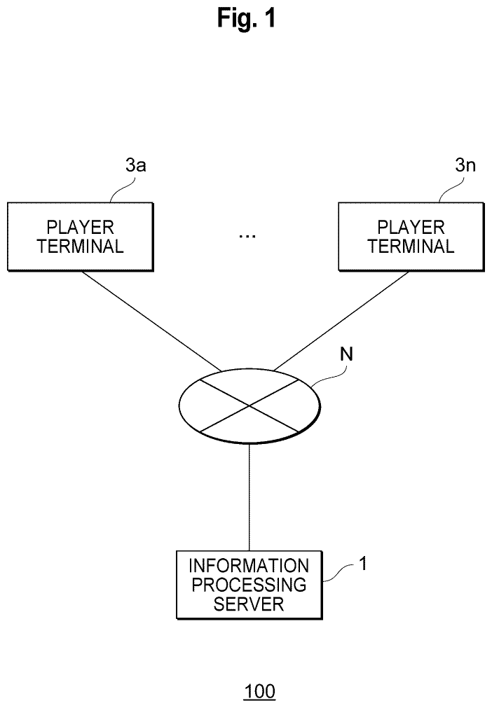

FIG. 1 is a block diagram showing the overall configuration of an information processing system 100 (virtual space providing system) according to a first embodiment of the present invention. As shown in FIG. 1, in an example, the information processing system 100 is configured so as to include an information processing server 1, n player terminals 3 (where n is a given integer equal to or greater than 1), and a network N.

The information processing system 100 is a so-called “client-server system.” The information processing system 100 is implemented by n player terminals 3, each being a client, and the information processing server 1 communicating with each other via the network N.

The information processing server 1 is implemented by, for example, one or more server devices. The player terminal 3 is implemented by, for example, a personal computer, a smartphone, or a gaming machine. The network N is implemented by, for example, a network, such as the Internet or a mobile phone network, a LAN (Local Area Network), or a combination of these networks. In the drawing, a player terminal 3a and a player terminal 3n are illustrated as n player terminals 3. However, when the following description explains these n player terminals 3 without particularly distinguishing them from one another, their reference numerals are abbreviated, and they are simply referred to as “player terminals 3.”

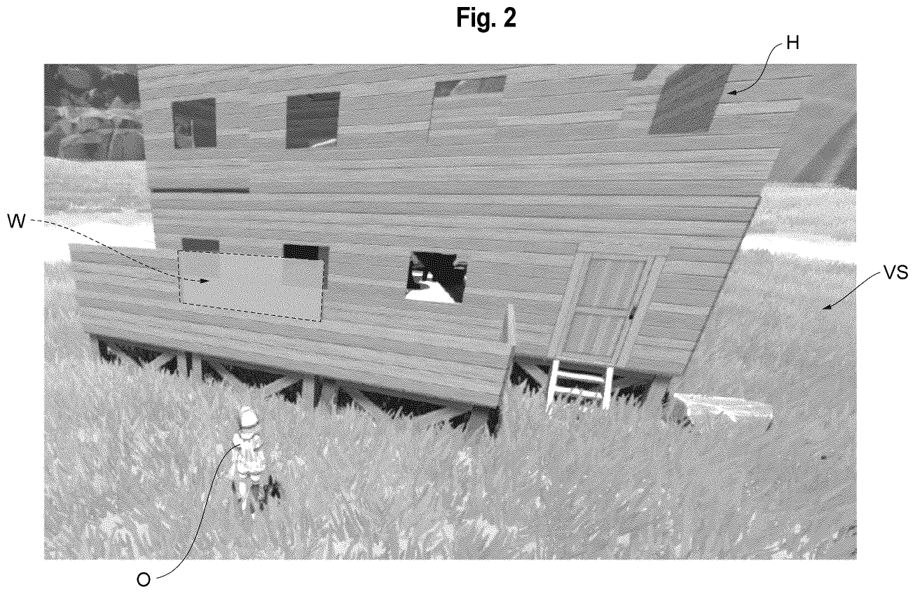

FIG. 2 is an overview illustrating an example of a crafting game according to the first embodiment of the present invention. As shown in FIG. 2, the information processing system 100 can execute a crafting game in which a player character (object O) operated by a player can create a virtual house H (a virtual structure) in a virtual space VS using one or more items (e.g., walls W) possessed by the player/player character as components of the house H. In such crafting game, it is possible to make at least one of virtual equipment, virtual devices, and virtual facilities, for use by the player characters.

A “player” is a user who operates a terminal device, and such term refers to a concept that corresponds to a client in the so-called “client-server system.” Typically, a “player” may participate in a virtual gaming space (virtual space) through a so-called “player character” (object O), etc., which acts, behaves, etc. in the virtual space on behalf of the player.

A “virtual space” refers to a virtually constructed space online, which includes, for example, a three-dimensional virtual space, but may also include a two-dimensional virtual space and others. In the following description, a virtual gaming space for performing a crafting game, for example, will be explained as an example of the “virtual space,” but the “virtual space” is not limited thereto. The “virtual space” may simply include a three-dimensional virtual space that is different from the real world, as well as services, etc. in such virtual space. For example, the “virtual space” may include a virtual space in which a player (player character) can communicate with other players.

Such “virtual space” includes one or more virtual spaces (e.g., metaverse spaces). In other words, a “virtual space” may collectively refer to multiple virtual spaces. When the “virtual space” includes a plurality of metaverse spaces, each user can move between different metaverse spaces by operating an avatar associated with the user. Furthermore, virtual content in a first virtual space that is generated and managed by a first management entity may also be usable in a second virtual space different from the first virtual space, that is generated and managed by a second management entity different from the first management entity. Virtual content refers to digital content in the virtual space, and examples thereof include avatars, buildings, fashion items, and the like. Virtual content can be created by users in the virtual space and such content may, for example, be sold to other users. Virtual content may also include “items,” which will be described later.

A “game” refers to, for example, a game in which each player operates a player character (object) that the player possesses. Such “game” includes a crafting game in which one or more player characters create a virtual structure, etc. using a plurality of items that the player characters possess as components of the virtual structure. Examples of the game may also include a fighting game in which a player character fights against an enemy character, a fighting game in which two or more player characters form a party and fight against an enemy character, and a fighting game in which one or more player characters fight against one or more other player characters. Examples of the “game” may also include a game in which player characters develop their own items (e.g., changing parameters of the items). It should be noted that the “game” is not limited to the above examples and may also include various other games, such as action games, quiz games, and card games.

An “item” refers to a medium that is used by a player character in the virtual space that the player participates in. Such items include those that give the player an advantage relative to other players or enemy characters in the progress of the game in the virtual space the player participates in, and the types of the items are not particularly limited.

“Items” include, for example, building materials, furniture, equipment, materials, and intermediate materials for creating materials in the virtual space. “Items” may also include virtual facilities or virtual devices in the virtual space. “Items” may also include dishes cooked by a player character in the virtual space or ingredients used for cooking in the virtual space. Such “items” include, for example, various items that increase the player's offensive ability, defensive ability, etc., but examples thereof are not limited to the above and may also include, for example, various items that increase damage to other players and enemy characters, or various items for restoring the player's stamina.

A “parameter” refers to information that is managed in association with a player character or an item. For example, “parameters” for a player character include information on the player character related to the progress of the game, such as the player character's offensive ability, defensive ability, or stamina indicating the physical strength of the character. “Parameters” for an item include, for example, parameters related to the weight of the item. The “parameters” may be determined according to the content of the gameplay. The “parameters” may be determined based on, for example, the difficulty or importance of the gameplay. Such “parameters” indicate something that gives a particular player character in a game that a player participates in, relatively advantageous or disadvantageous effects against other player characters in, for example, the progress of the game, and the types of the parameters are not particularly limited.

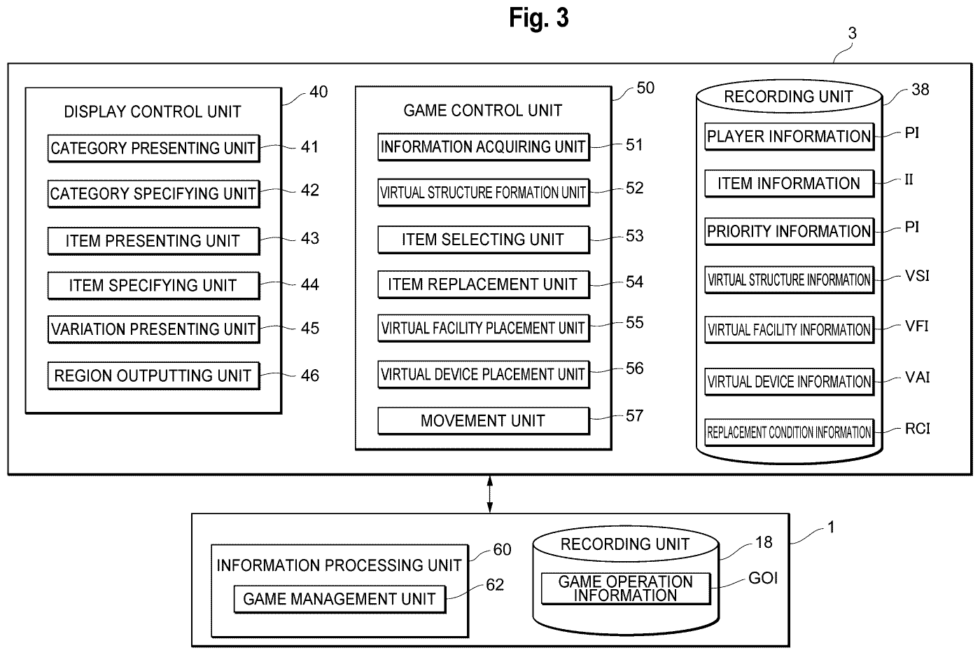

FIG. 3 is a block diagram showing an example of the functional configuration of the information processing server 1 and the functional configuration of the player terminal 3 according to the first embodiment of the present invention. In an example, the player terminal 3 is configured so as to include a game control unit 50 that controls the execution of the game, a display control unit 40 that controls display related to the game, and a recording unit 38 that records information related to the execution of the game.

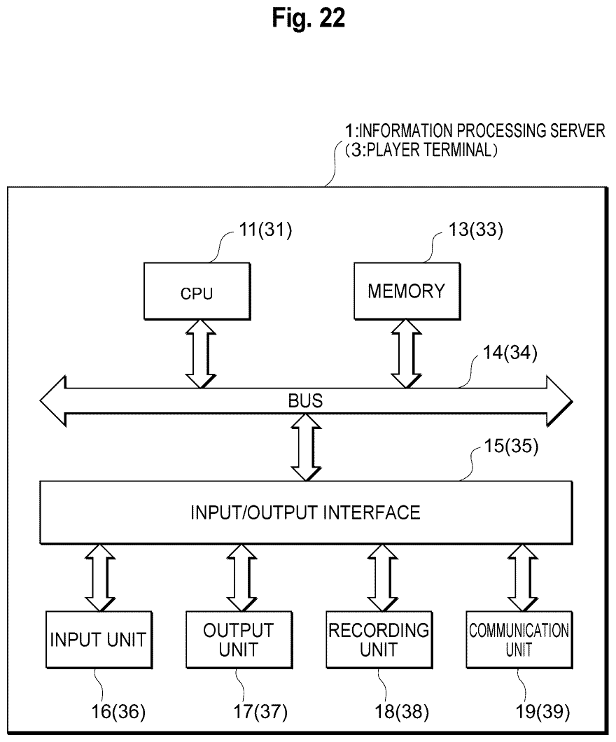

The game control unit 50 is configured so as to include, in terms of function, an information acquiring unit 51 (acquiring unit), a virtual structure formation unit 52 (formation unit), an item selecting unit 53 (selecting unit), an item replacement unit 54 (replacement unit), a virtual facility placement unit 55, a virtual device placement unit 56, and a movement unit 57. Each of the above parts of the game control unit 50 can be implemented by, for example, a CPU 31 executing programs stored in the recording unit 38 or in a memory 33 shown in FIG. 22.

The information acquiring unit 51 acquires item information related to a plurality of items used by a player character operated by a user in the virtual space. The information acquiring unit 51 may acquire item information II from the recording unit 38, and may also acquire item information II from a device or database external to the player terminal 3.

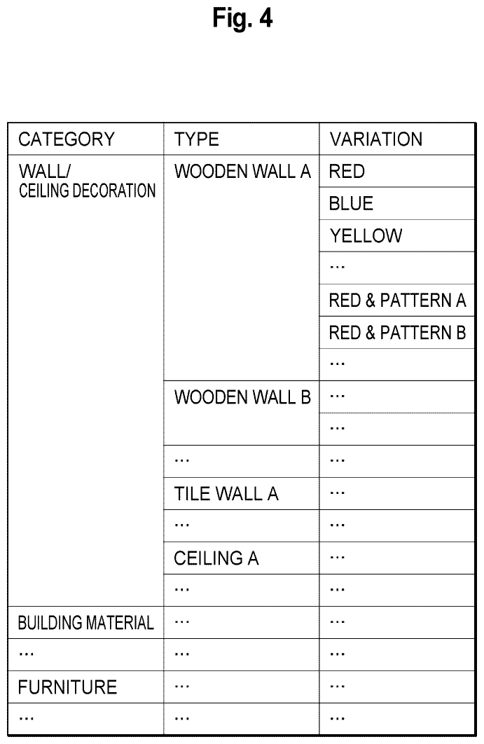

FIG. 4 is a diagram showing an example of item information according to the first embodiment of the present invention. As shown in FIG. 4, in item information II, each of a plurality of items used in the game is associated with information on “category,” “type,” and “variation.” For example, an item may be a wooden wall item which is of “wooden wall A” type in the “wall/ceiling decoration” category, with a “red” variation.

“Category” refers to information for distinguishing or classifying items. For example, such “category” may include information indicating that an item is related to “wall/ceiling decoration,” “building materials,” “furniture,” or “facilities.”

“Type” refers to information on the form or format, etc. of an item. For example, such “type” may be information for distinguishing a particular form of item among items classified into a particular “category” mentioned above. Such “type” may be, for example, information indicating what form of wall or ceiling the item is, such as “wooden wall A,” “wooden wall B,” “tile wall A,” or “ceiling A,” etc.

“Variation” refers to information regarding modifications or varieties, etc. of an item. For example, such “variation” may include information on the size, weight, color, color tone, pattern, or material, etc. of an item. Items of a common or identical “variation” may refer to, for example, items in a common or identical color, and items of different “variations” may refer to, for example, items in different colors.

Referring back to FIG. 3, the virtual structure formation unit 52 creates (forms) one or more virtual structures based on a plurality of items. For example, the virtual structure formation unit 52 creates a virtual building by combining items, such as walls, ceilings, roofs, and doors, which are specified by input from the user. The virtual structure may include, for example, virtual buildings (e.g., a house), or furniture, such as a kitchen table, lighting devices, or bookshelves. The virtual structure may also include, for example, a virtual facility (a virtually established facility). Such virtual facilities may include, for example, factories, laboratories, bridges, bases, roads, railways, towers, plantations, fountains, zoos, or aquariums. The virtual facilities may also include virtual storage facilities described below.

The item selecting unit 53 selects items of a common variation associated with a plurality of items, based on a user input. For example, in a case where a plurality of walls forming a house (which is a virtual structure) have a different color from each other, the item selecting unit 53 selects walls having a common color (e.g., red) associated with the plurality of walls, based on a user input, in order to organize (rearrange) the walls in a common color (e.g., red). The user input may be made in a given manner, and items of a desired variation may be selected, for example, by operating a mouse of an input unit 36 of the player terminal 3 operated by the player.

When a plurality of items forming one or more virtual structures satisfy a predetermined condition, the item replacement unit 54 rearranges (replaces) at least a portion of the plurality of items with items of a common variation.

The “one or more virtual structures,” being a replacement target, may be determined by a given method, and examples thereof include those described in (i) to (vi) below.
(i) A method in which a “single structure” in a predefined range of the virtual space (e.g., a target area for crafting) is automatically determined as a replacement target.
(ii) A method in which “all of a plurality of structures” in a predefined range of the virtual space are automatically determined as replacement targets.
(iii) A method in which “one or more selected structures” in a predefined range of the virtual space is/are automatically determined as replacement target(s).
(iv) A method in which a “single structure” in the virtual space is determined as a replacement target in response to the user's operation of selection, regardless of the range (whatever range the structure is in).
(v) A method in which “a plurality of structures” in the virtual space are determined as replacement targets in response to the user's operation of selection, regardless of the range (whatever range the structures are in).
(vi) A method in which “all of a plurality of structures” in the virtual space are automatically determined as replacement targets, regardless of the range (whatever range the structures are in).

A given method may be used to determine whether or not something corresponds to a “virtual structure,” and examples thereof include the methods described in (i) to (iii) below.
(i) A method in which a virtual structure that is placed in a particular range of the virtual space is determined as corresponding to a “virtual structure,” when the particular range is specified by the user's operation.
(ii) A method in which, for example, one or more virtual building materials (items) that are placed in the virtual space are determined as corresponding to a “virtual structure.” In other words, an unfinished structure may also be determined as corresponding to a “virtual structure” if one or more virtual building materials (items) are placed.
(iii) A method in which a combination of virtual walls and virtual floors is determined as corresponding to a “virtual structure,” if the virtual walls and virtual floors are placed in the virtual space to an extent that a certain space can be recognized.

The “predetermined condition” includes, for example, those mentioned in (i) to (iv) below. It should be noted here that “replacing at least a portion of the plurality of items with . . . ” includes replacing all of the plurality of items and replacing a portion of the plurality of items.
(i) A plurality of items forming one or more virtual structures are items of a common type.
(ii) A plurality of items forming one or more virtual structures are items of a common type and they are placed adjacent to each other in the virtual space.
(iii) A plurality of items forming one or more virtual structures are items of a common type and they are placed in a particular range of the virtual space that is specified by the user.
(iv) A plurality of items forming one or more virtual structures are items of a common type and they form a single virtual structure placed in the virtual space that is specified by the user.

Regarding condition (i), for example, when a plurality of items forming one or more virtual structures (e.g., a house) are items of a common type (e.g., wooden wall A), the item replacement unit 54 may replace at least a portion of the plurality of items (e.g., items of wooden wall A) with items of a common variation (e.g., items of red wooden wall A).

Regarding condition (ii), for example, when a plurality of items forming one or more virtual structures (e.g., a house) are items of a common type (e.g., wooden wall A) and they are placed adjacent to each other in the virtual space, the item replacement unit 54 may replace at least a portion of the plurality of items (e.g., adjacent items of wooden wall A) with items of a common variation (e.g., items of red wooden wall A).

Regarding condition (iii), for example, when a plurality of items forming one or more virtual structures (e.g., a house) are items of a common type (e.g., wooden wall A) and they are placed in a particular range of the virtual space that is specified by the user, the item replacement unit 54 may replace at least a portion of the plurality of items (e.g., items of wooden wall A in the specified particular range) with items of a common variation (e.g., items of red wooden wall A).

Regarding condition (iv), for example, when a plurality of items forming one or more virtual structures (e.g., a house) are items of a common type (e.g., wooden wall A) and they form a single virtual structure placed in the virtual space that is specified by the user, the item replacement unit 54 may replace at least a portion of the plurality of items (e.g., items of wooden wall A forming the specified single virtual structure) with items of a common variation (e.g., items of red wooden wall A).

“Items of a common type,” which can be subject to replacement, may be set in advance by the player (user). Such “items of a common type” may include items of one or more common types. For example, “items of a common type” may include “wooden wall” items only, may include “wooden wall” items and “pillar” items, or may include “tile wall” items and “roof” items. The “items of a common type” that are set in advance may be changed as appropriate.

Each of the above-indicated conditions shares a common condition of “a plurality of items forming one or more virtual structures” being “items of a common type”; however, such common condition is not limited to the above. For example, instead of the above-mentioned common condition, a common condition shared by the respective conditions may include “a plurality of items forming one or more virtual structures” being items of a “common” category.

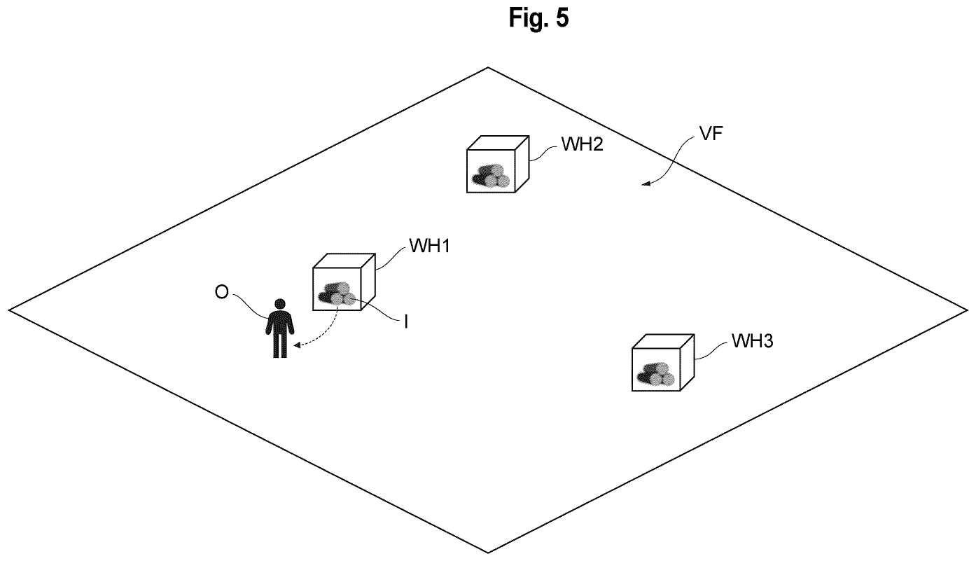

The virtual facility placement unit 55 places virtual facilities in the virtual space. For example, the virtual facility placement unit 55 may place, in the virtual space, a virtual warehouse (a virtual storage facility) capable of storing a plurality of items therein. For example, the virtual facility placement unit 55 may automatically place, in each of a plurality of predetermined virtual fields (areas) of the virtual space, one or more particular virtual facilities associated with the field. The virtual facility placement unit 55 may also place, in the virtual space, one or more virtual facilities that are specified by a user input. Features of the virtual warehouse, which is an example of the virtual storage facility capable of storing a plurality of items therein, will now be described with reference to FIG. 5.

As shown in FIG. 5, the virtual facility placement unit 55 places one or more virtual warehouses WH1, WH2, WH3 in a virtual field VF of the virtual space. When an object O, which is operated by the player, comes close to the virtual warehouse WH1, for example, the object O can take out an item I stored in the virtual warehouse WH1 and use the obtained item I to make a certain virtual structure. Each item has, for example, a weight parameter, and the object O has a limit on the weight of one or more items that the object O can carry. Accordingly, if the object O exceeds such weight limit as a result of carrying a certain new item therewith, the item may be stored in the virtual warehouse. In this way, the object O is able to keep such item as its possessed item even though it cannot carry the item therewith. If the user does not want to store the item that the user is going to obtain as a new item in the virtual warehouse, such user may select the operation of not storing the item (and therefore not obtaining the item). Further, when the total weight of the one or more items that the object O is carrying therewith reaches the weight limit, the object O cannot withdraw a new item from the virtual warehouse.

An upper limit may also be set on the number of items that the object O can carry therewith. In other words, the object O cannot carry more items than the upper limit number of items, and accordingly, any items that exceed the upper limit number may be stored in the virtual warehouse. Such upper limit on the number of items to carry may be set for each type of item. Such upper limit on the number of items to carry may simply be an upper limit value on the number of items that the object O can carry therewith.

There may be a given number of virtual warehouses, which is three in the example shown in FIG. 5; however, the number is not limited to such example. The virtual storage facilities include a virtual above-ground warehouse or storehouse located above the ground, as well as a virtual warehouse or storehouse located underground.

The virtual device placement unit 56 places a protect cube (PQ) (a virtual device) in the virtual space, wherein the protect cube (PQ) is a device that provides a predetermined effect in a predetermined range of the virtual space based on the position in which the protect cube (PQ) is placed in the virtual space. For example, the virtual device placement unit 56 may automatically place one or more particular virtual devices associated with each of a plurality of predetermined areas of the virtual space, at predetermined positions in the virtual space. There are one or more such “areas” on a virtual field (e.g., a map in the game). The object O can shift from one area to another as it moves over the virtual field. The areas may be separated based on, for example, the topography of the virtual field, or such separation may be arbitrarily performed depending on the virtual field according to the game system. Examples of such “area” include a plain, a forest, a wilderness, a desert, or a marsh in the virtual space.

The “area” may include different maps (virtual fields) in which the object O can move upon load (read) processing in the game.

Each PQ is placed in the virtual space such that the “predetermined range” associated with the PQ is included in one area. In other words, PQs are configured so as to be able to provide their effect in one area.

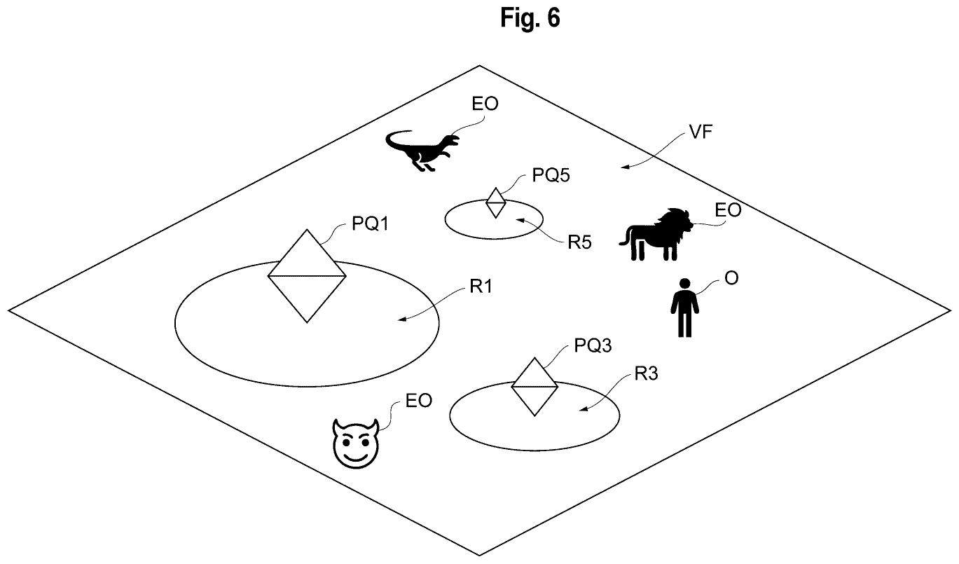

The virtual device placement unit 56 may place one or more virtual devices specified by a user input at predetermined positions in the virtual space. Features of the PQ, which is an example of a virtual device, will now be described with reference to FIGS. 6-8.

As shown in FIG. 6, for example, a plurality of protect cubes PQ1, PQ3, and PQ5 are placed in the virtual field VF. Each of the plurality of protect cubes PQ1, PQ3, and PQ5 is displayed in a different form according to the virtual field VF. For example, the protect cubes PQ1, PQ3, and PQ5 each have a different display size (dimension). The respective safety zones (predetermined ranges) associated with the protect cubes PQ1, PQ3, and PQ5 are set according to the form in which the PQ is displayed. For example, for the protect cube PQ1 having the largest display size, a safety zone R1, which is the largest in size, is displayed. For the protect cube PQ5 having the smallest display size, a safety zone R5, which is the smallest in size, is displayed. For the protect cube PQ3 having the medium display size, a safety zone R3, which is smaller than the safety zone R1 but larger than the safety zone R5, is displayed.

Here, the “predetermined effect” in the “predetermined range” includes an effect that gives an advantage relative to other player characters, etc., and the types of such effect are not particularly limited. The “predetermined effect” may include, for example, a state in which an enemy character EO different from the object O operated by the user does not appear in the safety zone R1, R3, R5. Further, the safety zone associated with the object O may be given the effect of prohibiting player characters operated by other players from entering the zone. There may be a given number of PQs and there are three PQs in the example shown in FIG. 6; however, the number is not limited to such example.

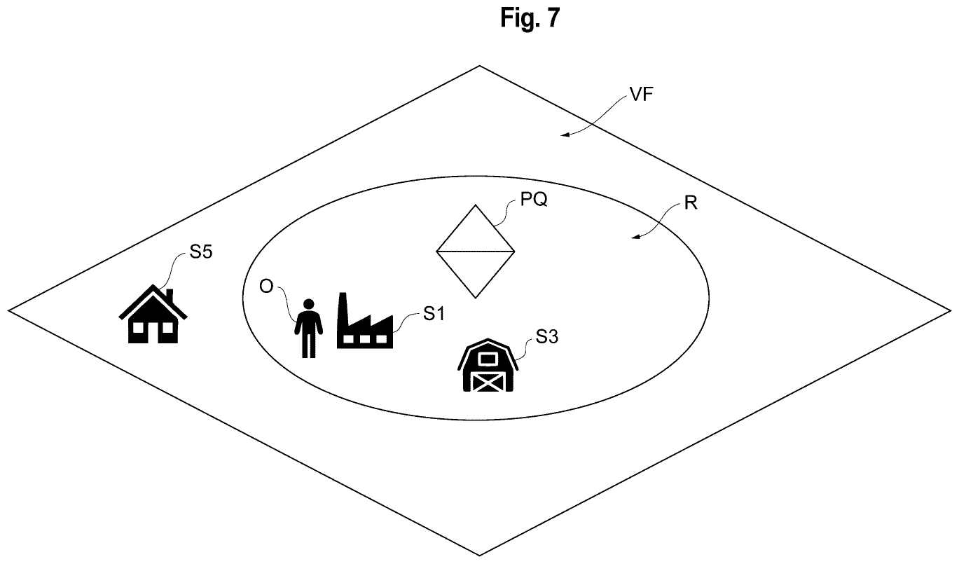

The “predetermined effect” includes a state in which a particular virtual structure from among one or more virtual structures can be placed in the “predetermined range.” As shown in FIG. 7, in the safety zone R for the protect cube PQ, particular virtual buildings S1 and S3 from among a plurality of virtual buildings S1, S3 and S5 are allowed to be placed in the virtual field VF. Each virtual structure is associated with its rank for indicating the uniqueness, value, etc. of the virtual structure. Both the virtual building S5, which is an ordinary building having a predetermined rank or under, such as a virtual house, and the particular virtual buildings S1 and S3, which are at or above a predetermined rank, can be placed in the safety zone R. For example, the particular virtual buildings S1 and S3 are a virtual factory and a virtual power plant, respectively. More specifically, particular virtual buildings, such as virtual factories or virtual power plants, can be placed and run in the safety zone R, and such virtual buildings will not be placed in portions of the virtual field VF other than the safety zone R. Such particular virtual buildings may also include industrial furnaces, large refrigerators, teleporters, and the like.

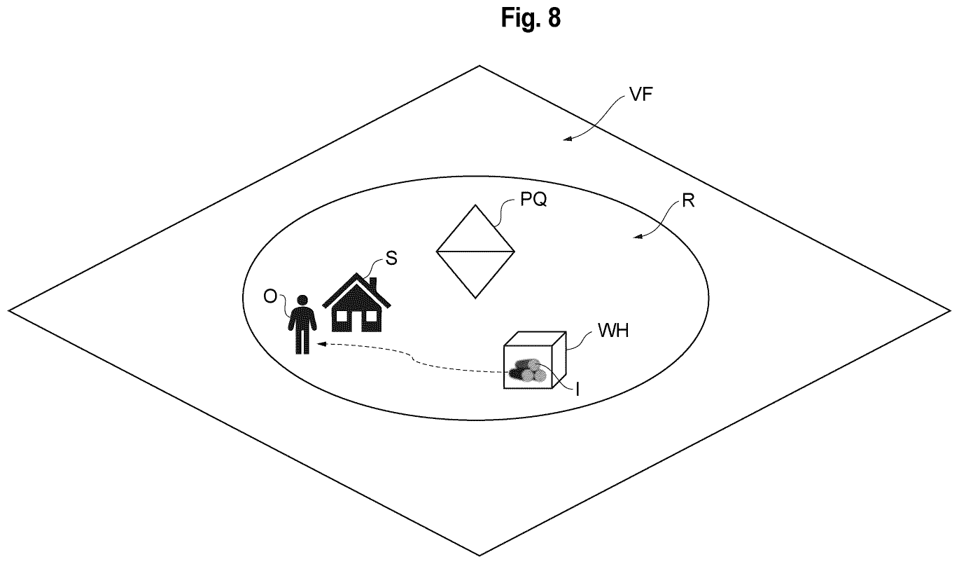

As shown in FIG. 8, when a virtual warehouse WH is placed in the safety zone R for the protect cube PQ, and if the object O is staying in such safety zone R, the virtual structure formation unit 52 shown in FIG. 3 obtains one or more items I out of the virtual warehouse WH based on an input from the user who operates the object O, and forms one or more virtual buildings S using the obtained one or more items I. In other words, as long as the object O is in the safety zone R, it can create virtual buildings S without going to the virtual warehouse WH (even if the object O is located away from the virtual warehouse WH).

Usually, when an object O wishes to create a virtual structure, the object O can only use items that it carries, such as in its backpack or bag. However, the use of the virtual warehouse WH allows for the storage of items that the object O cannot or does not carry therewith. In this way, when the object O is staying in the safety zone R, it can freely take desired items at any time out of the virtual warehouse WH placed in the safety zone R and use them to create a virtual structure.

In the present embodiment, in a portion of the virtual field VF other than the safety zone R, the object O cannot store items in, or take items from, the virtual warehouse WH. By placing certain limitations on the acquisition and use of items, it is possible to maintain the player's motivation to not only perform crafting work but also to fight enemy characters, etc. to acquire items, and to also improve the entertaining nature of the game.

In the meantime, if the status (e.g., the offensive and defensive abilities) of the object O increases as the user proceeds through the game and the object O is put in a condition of carrying many items of building materials, the user may be more strongly motivated to further proceed with performing crafting work (as an element of challenge), instead of fighting with enemy characters. Accordingly, as a result of proceeding with the game in order to conquer the game, the users are allowed to expand the predetermined range of a protect cube PQ, to make the protect cube PQ itself replaceable with a bigger one, or to increase the number of protect cubes PQ placed in one area. Conquering the game includes, for example, defeating a boss enemy character that exists in each area among other enemy characters, acquiring a particular item, or completing a particular event.

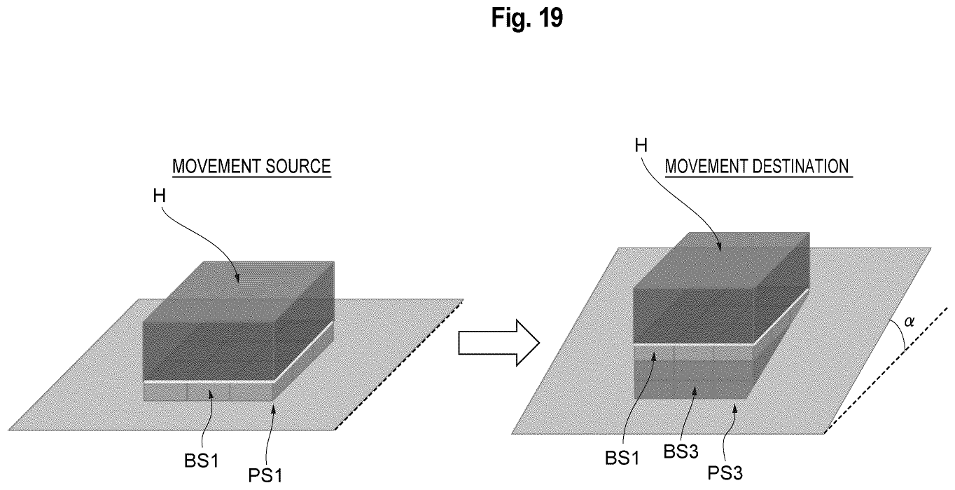

Returning to FIG. 3, the movement unit 57 moves one or more virtual structures in the virtual space. The movement unit 57 moves one or more virtual structures that are specified based on an input from the user. For example, when the movement unit 57 moves one or more virtual structures placed on a first placement surface in the virtual space to a second placement surface having a different inclination from that of the first placement surface, it places the one or more virtual structures on the second placement surface based on such inclination. The more specific method for such movement will be described in more detail below with reference to FIG. 19. The movement unit 57 may also move, for example, at least one of a virtual facility and a virtual device in the virtual space in a similar way to the above-mentioned method for moving a virtual structure.

The display control unit 40 is configured so as to include, in terms of function, a category presenting unit 41, a category specifying unit 42, an item presenting unit 43, an item specifying unit 44, a variation presenting unit 45, and a region outputting unit 46. Each unit of the display control unit 40 can be implemented by, for example, the CPU 31 executing programs stored in the recording unit 38 or in the memory 33 shown in FIG. 22.

The category presenting unit 41 presents, on the screen, one or more categories related to one or more items used by a player character in the virtual space in a manner whereby a category can be specified.

The category specifying unit 42 specifies a particular category from among the one or more categories, based on a user input.

The item presenting unit 43 presents, on the screen, one or more items associated with the particular category specified by the category specifying unit 42, in a manner whereby an item can be specified. For example, based on a predetermined level of priority, the item presenting unit 43 presents one or more items associated with the particular category specified. With this configuration, for example, items with higher priority can be presented on the screen in a manner that the player can easily specify such items with higher priority.

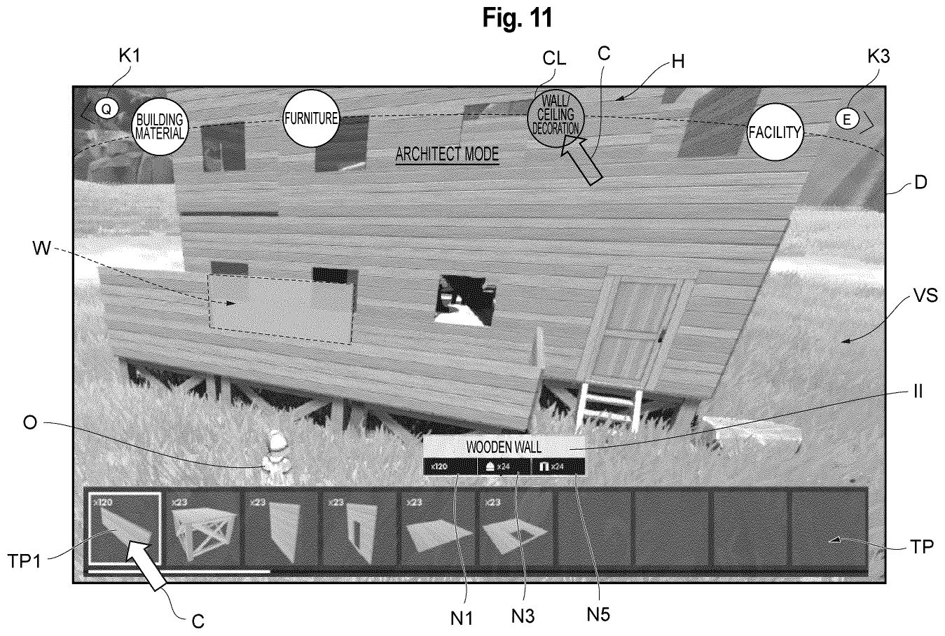

Any method may be used for the presentation. For example, the item presenting unit 43 may present items with higher priority on the left side and items with lower priority on the right side in a region for presenting particular types TP on the screen, such as the one shown in FIG. 11. When items are listed vertically on the screen, the item presenting unit 43 may present items with higher priority at the upper part and items with lower priority at the bottom part. Furthermore, the item presenting unit 43 may add emphasis on items with higher priority, as compared to items with lower priority.

The “predetermined level of priority” is determined based on information which is, for example, at least one of: identification information of each item; the status of possession of one or more items by the object O; and the status of use of one or more items by the object O.

The “status of possession of one or more items” includes a status of whether or not one or more items are possessed by the object O, including, for example, a status of whether or not one or more items have been purchased by the object O. For example, the item presenting unit 43 may present purchased items (items with higher priority) on the left side and unpurchased items (items with lower priority) on the right side in the region for presenting particular types TP on the screen, such as the one shown in FIG. 11.

The “status of use of one or more items” includes a status of the current or previous use of item(s) by the object O. A status of current use includes, for example, a status of use of items that are currently used for crafting which is being performed by the object O, and a status of use of items that are related to a virtual structure that is going to be made. More specifically, the item presenting unit 43 may place priority on items having high relevancy with the items that are currently used for crafting, or items that are highly likely to be used for a virtual structure that is going to be made, and present such items as items with higher priority.

A status of previous use includes the fact of one or more items having been used a predetermined threshold number of times or more, or at a predetermined threshold frequency or more, for the item most recently used by the object O. Since an item that has been used a predetermined threshold number of times or more, or at a predetermined threshold frequency or more, for the item most recently used by the object O is an item that is highly likely to be used by the object O, such item is presented with higher priority so that the object O can easily specify the item.

When the object O is in a battle with an enemy character, the item presenting unit 43 may present items related to weapons, which are likely to be used in the battle, with higher priority than items related to walls and ceilings, which are likely to be used for crafting. If there is a restriction on the items that the object O can use according to its level, then the item presenting unit 43 may give priority to items that the object O of a certain level is allowed to use and present such items.

The “predetermined level of priority” may be changed as appropriate by the player. The player may be able to sort the items based on such priority levels. For example, with the use of the sorting feature, unpurchased (unpossessed) items may be given priority for display on the screen. This configuration will facilitate the player to purchase unpurchased items.

After presenting, on the screen, one or more items associated with the particular category specified by the category specifying unit 42 in a manner whereby an item can be specified, the item presenting unit may further present the number of items that the user possesses for a particular item specified by the item specifying unit 44 (described below), in association with the particular item specified.

The item specifying unit 44 specifies a particular item from among the one or more items based on an input from the user.

The variation presenting unit 45 presents, on the screen, one or more variation items related to the particular item specified by the item specifying unit 44, in association with the particular item specified, in a manner whereby a variation item can be specified.

The region outputting unit 46 outputs a predetermined region for receiving a user input on the screen. For example, when a first variation item that is not possessed by the user is specified from among a plurality of variation items for the particular item, based on a user input, the region outputting unit 46 outputs an input receiving region for receiving a user input for the user to at least obtain the first variation item on the screen.

The recording unit 38 records, for example, player information PI, item information II, priority information PI, virtual structure information VSI, virtual facility information VFI, virtual device information VAI, and replacement condition information RCI. Such item information II, priority information PI, virtual structure information VSI, virtual facility information VFI, virtual device information VAI, and replacement condition information RCI are recorded in association with each player (user).

The player information PI records, for example, the following information in association with one another: identification information of one or more players, player characters each player has, and identification information of the game that each player plays using the player characters. Further, the player information PI may be recorded for each of the one or more players (player characters), in association with item information II for the items possessed by the player (player character).

The priority information PI is information relating to the level of priority based on which the item presenting unit 43 presents items. In other words, the priority information PI is information regarding the above-described “predetermined level of priority.”

The virtual structure information VSI is information on a virtual structure. The virtual structure information VSI includes, for example, identification information of the virtual structure and identification information of one or more items forming the virtual structure. The virtual structure information VSI includes information on the area where the virtual structure is placed in the virtual space, the position at which the virtual structure is placed, the inclination of the virtual field at which the virtual structure is placed, and the like.

The virtual facility information VFI is information related to the virtual facility. The virtual facility information VFI includes, for example, identification information of the virtual facility and identification information of one or more items forming the virtual facility. The virtual facility information VFI includes information on the area where the virtual facility is placed in the virtual space, the position at which the virtual facility is placed, the inclination of the virtual field at which the virtual facility is placed, and the like.

The virtual device information VAI is information on a virtual device. The virtual device information VAI includes identification information of the virtual device, as well as information regarding the display size in the virtual space for each virtual device, the range (display size) of the safety zone associated with the virtual device, and the content of the “predetermined effect.” The virtual device information VAI may also include information on the area where the virtual device is placed in the virtual space, the position at which it is placed, the inclination of the virtual field at which it is placed, and the like.

The replacement condition information RCI is information regarding conditions that are referenced by the item replacement unit 54 when executing the replacement processing. The replacement condition information RCI includes, for example, information on the above-described predetermined conditions (i) to (iv).

The recording unit 38 may further record information for generating the virtual space. The recording unit 38 includes, for example, one or more virtual gaming space data templates for defining a virtual space VS as shown in FIG. 2.

In an example, the information processing server 1 is configured so as to include an information processing unit 60 that executes information processing for managing the crafting game, and a recording unit 18 that records information relating to the information processing for managing the crafting game.

The information processing unit 60 is configured so as to include, in terms of function, a game management unit 62. The information processing unit 60 can be implemented by, for example, a CPU 11 executing programs stored in the recording unit 18 or in a memory 13 as shown in FIG. 22.

The game management unit 62 executes processing for operating and managing the game. The game management unit 62 operates the game based on gaming software included in the game operation information GOI recorded on the recording unit 18 and the content of the player's operation input through the input unit 36 shown in FIG. 22.

The game management unit 62 automatically executes processing for managing the crafting game based on, for example, parameters associated with each of a plurality of player characters participating in the crafting game, setting information connected with the crafting game (such as the type of the crafting game and rewards that a player or player character can obtain when it completes a challenge), and information on player inputs obtained via the player terminal 3 (such as the player's selection of the content of a game that the player wishes to play), and the information processing server 1 automatically executes processing for managing the crafting game. The game management unit 62 records the results of the crafting game processing (e.g., log information) in the recording unit 18.

The parameters, the setting information connected with the crafting game, and the information on the player's inputs may be recorded in the recording unit 18 in advance as game operation information GOI. Furthermore, the game management unit 62 performs the game management processing based on image data also included in the game operation information GOI, as well as music data and voice data included in the game operation information GOI.

As described above, various types of information related to the game executed by the game management unit 62, such as game operation information GOI and log information, are managed by the information processing server 1. Thus, when processing that occurs during the game involves changes to such various types of information, the game management unit 62 communicates with the player terminal 3 so as to cause various types of information managed by the player terminal 3 to be updated. Examples of processing involving changes to the various types of information include processing that involves changes to the content of the game, such as the player character's parameters, items owned by the player character, and facilities made by the player character.

When the game is managed on the side of the player terminal 3 (in the case of a second embodiment described later), the game management unit 62 provides the player terminal 3 with necessary information for management, etc. of the game. The game management unit 62 may obtain, at a given timing from the player terminal 3, information updated based on the progress of the game being executed by the player terminal 3, and manage the obtained updated information.

### First Example: Craft Processing

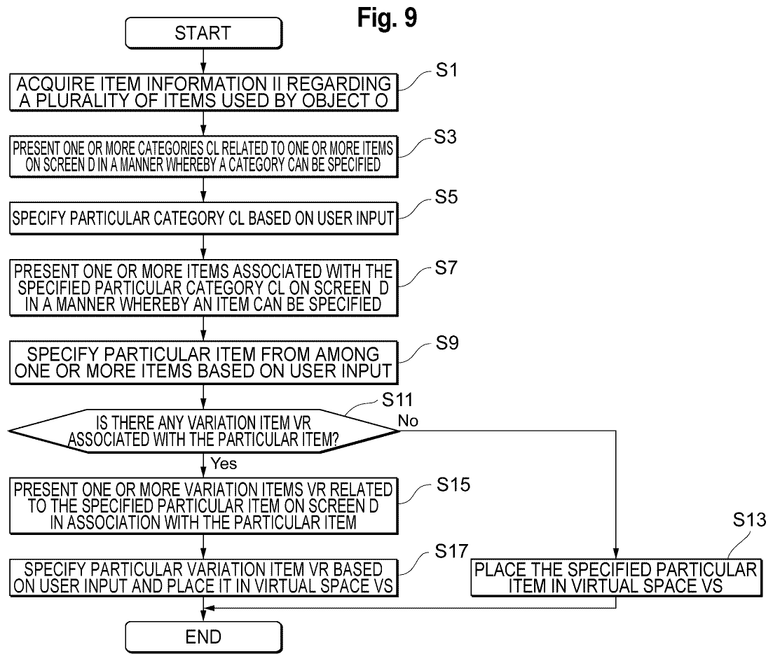

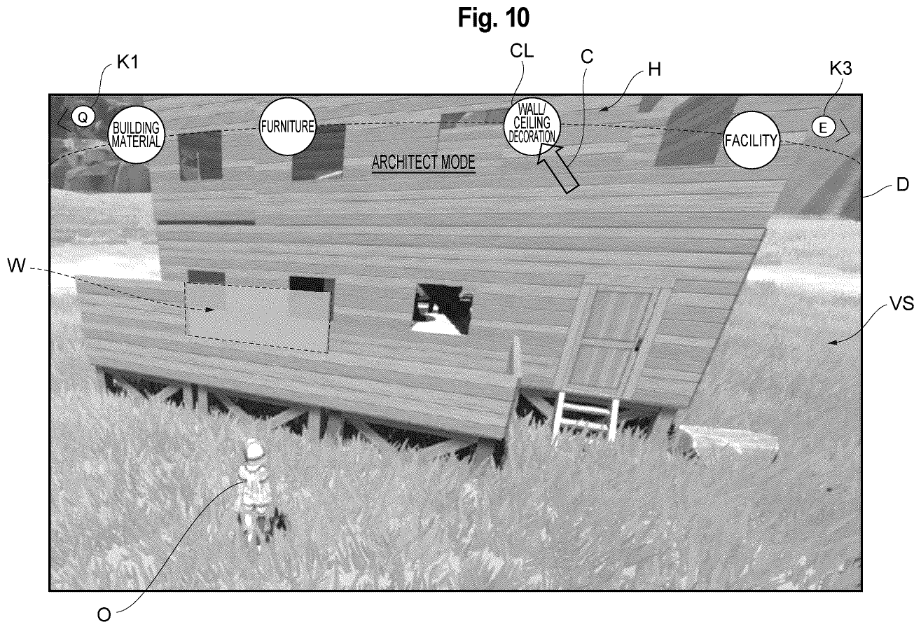

Craft processing according to a first example of the first embodiment of the present invention will now be described with reference to FIGS. 9 to 12. FIG. 9 is a flowchart showing an example of the craft processing according to the first embodiment of the present invention. FIGS. 10 to 12 each illustrate an example of the screen of the output unit 37 of the player terminal 3. In particular, FIGS. 10 to 12 are example screens for explaining an example of the player's (user's) crafting operation (e.g., an architect mode).

As shown in FIG. 9, the information acquiring unit 51 of the information processing system 100 acquires item information II regarding a plurality of items used by an object O operated by a player (user) in a virtual space VS (step S1).

As shown in FIG. 10, the category presenting unit 41 of the information processing system 100 presents, on a screen D, one or more categories CL related to one or more items used by the object O in the virtual space VS in a manner whereby a category can be specified (step S3). The information processing system 100 specifies a particular category (e.g., “wall/ceiling decoration”) from among the one or more categories CL based on a user input (step S5 in FIG. 9).

A “user input” includes an input from the user made via the input unit 36 of the player terminal 3. For example, such “user input” includes an input via a cursor C which behaves in response to the user's operation on a mouse, etc. of the input unit 36 of the player terminal 3 (such as a click operation, a double-click operation, or an operation of stopping the cursor C on a category CL icon for a certain period of time). Any method can be used to present one or more categories CL and, for example, one or more categories CL may be presented so as to be lined up in the right/left direction on the upper part of the screen D as shown in FIG. 10. For example, the one or more categories CL may be scrolled to the left when the user presses the “Q” key K1 on the keyboard of the input unit 36, while the one or more categories CL may be scrolled to the right when the user presses the “E” key K3.

As shown in FIG. 11, the item presenting unit 44 of the information processing system 100 presents, on the screen D, one or more items associated with the specified particular category (e.g., “wall/ceiling decoration”) in a manner whereby an item can be specified (step S7 in FIG. 9). For example, the information processing system 100 may present one or more types TP of items for the specified particular category on the lower side of the screen D such that the items are lined up in the right/left direction according to a predetermined level of priority.

The item specifying unit 44 of the information processing system 100 specifies an item of a particular type TP1 (e.g., “wooden wall”) from among the one or more items, based on a user input (e.g., an input through the operation of the cursor C) (step S9 in FIG. 9). As shown in FIG. 11, when the item of a particular type TP1 is specified, item information II for the particular type TP1 is output on the screen D. This configuration enables the user to easily understand the information regarding the item of a particular type TP1 that has been specified by the user themself.

In the item information II, the portion “×120” N1 indicates, for example, the number of items of the “wooden wall” type that are owned by the object O. For example, all of the 120 “wooden wall” type items may be available as “wooden wall” type items with a common variation (e.g., red), or available as “wooden wall” type items with different variations (e.g., red and blue). In other words, the 120 “wooden wall” type items may be available as 100 “wooden wall” type items in “blue” and 20 “wooden wall” type items in “red.” The portion “×24” N3 with an icon in the shape of a backpack indicates the number of “wooden wall” type items that the object O carries therewith. The portion “×24” N5 with an icon in the shape of a warehouse indicates the number of “wooden wall” type items that the object O stores in a virtual warehouse.

The blank portions in the region for displaying the type TP will be filled as the number of types that the object O carries (or possesses) increases. In the example of FIG. 11, 10 types can be displayed on the screen D; however, when the number of types exceeds 10, the user may perform, for example, a scrolling operation on the screen D so as to display other types that are not currently displayed on the screen D.

The variation presenting unit 45 of the information processing system 100 determines whether or not the specified particular item has variation items associated therewith, by referring to, for example, the item information II recorded on the recording unit 38 shown in FIG. 3 (step S11 in FIG. 9). If there is no variation item associated with the specified particular item (No in step S11), the processing goes to step S13. As shown in FIG. 11, the information processing system 100 places the particular item of type TP1, which is specified based on the user input, on a wall portion W of a virtual house H that is in the process of being crafted (step S13).

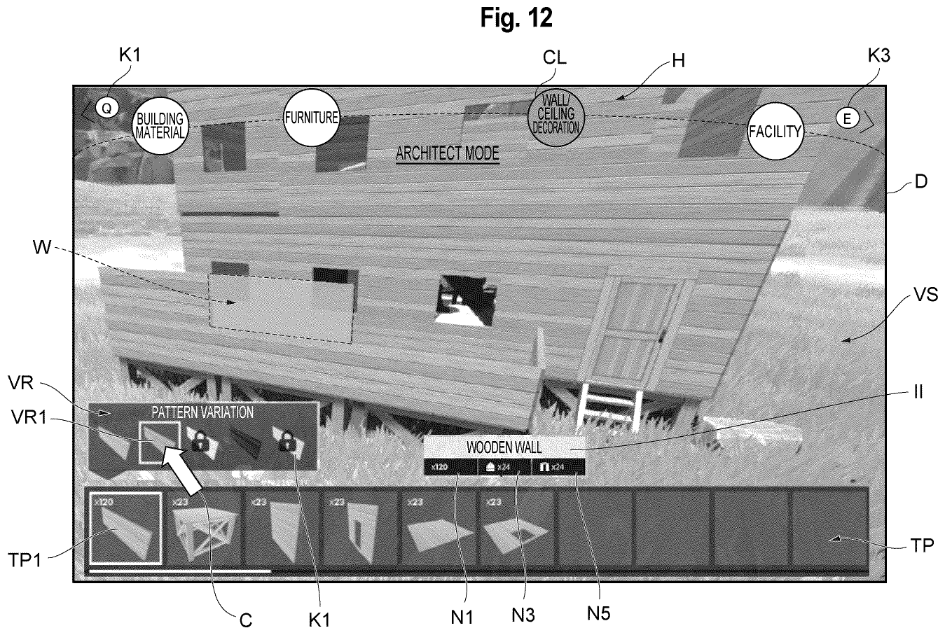

On the other hand, if there is a variation item associated with the specified particular item (Yes in step S11), the processing goes to step S15. As shown in FIG. 12, the variation presenting unit 45 presents items of one or more variations VR for the specified particular item on the screen D in association with the particular item in a manner whereby a variation item can be specified (step S15 in FIG. 9). Next, as shown in FIG. 11, when an item of a particular variation VR1 (e.g., an item of the “wooden wall” type in the “wall/ceiling decoration” category in orange color) is specified based on a user input made through the operation of the cursor C, the information processing system 100 places the particular variation item on the wall portion W of the virtual house H that is in the process of being crafted (step S17 in FIG. 9).

The variation presenting unit 45 of the information processing system 100 may present, among a plurality of variation items related to a particular item, a first variation item possessed by the user and a second variation item not possessed by the user in different forms. For example, as shown in FIG. 12, the variation presenting unit 45 may present the second variation item in such a manner that a key icon KI is superimposed on the item. Meanwhile, the first variation item possessed by the user is presented with no such key icon being superimposed thereon. This configuration enables each user to easily understand the items it possesses.

The second variation item may be presented in any manner. For example, in addition to superimposing the key icon KI, the variation presenting unit 45 may gray-out the second variation item, make it translucent, or display it in a smaller size than that of the first variation item.

For example, if there are multiple second variation items and the object O has enough money to purchase one of the multiple second variation items while the object O is unable to purchase the other items, the key icon superimposed on the one item may be displayed in a different form than the key icons superimposed on the other items. For example, a key icon displayed in red may be superimposed on the one item, while a blue key icon may be superimposed on the other items.

According to the first example of the present embodiment, the information processing system 100 presents, on the screen, one or more variation items for a particular item specified in association with the particular item in a manner whereby a variation item can be specified. Thus, the user is able to specify a variation item for the particular item in an efficient manner.

### Second Example: Item Replacement Processing

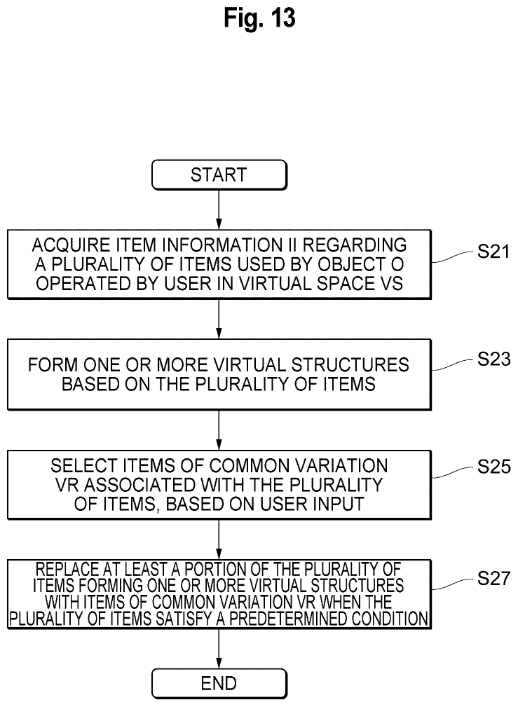

Item replacement processing according to a second example of the first embodiment of the present invention will now be described with reference to FIGS. 13-15. FIG. 13 is a flowchart showing an example of the item replacement processing according to the first embodiment of the present invention. As shown in FIG. 13, the information acquiring unit 51 shown in FIG. 3 acquires item information regarding a plurality of items used by an object O operated by a user in a virtual space VS (step S21). The virtual structure formation unit 52 forms one or more virtual structures based on the plurality of items (step S23). The item selecting unit 53 selects items of a common variation VR associated with the plurality of items, based on a user input (step S25).

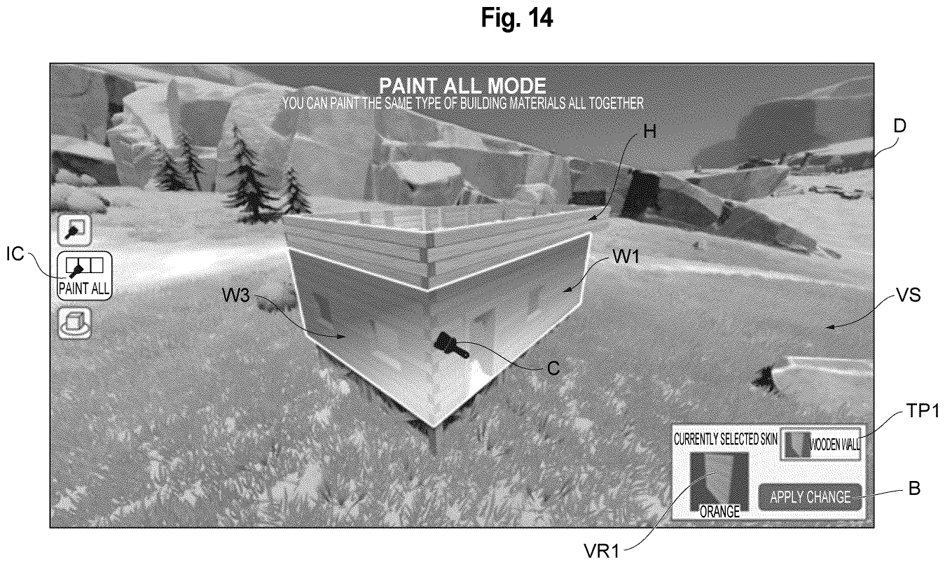

As shown in FIG. 14, when the user operates the player terminal 3 to select a “Paint All” icon IC on the screen D, the information processing system 100 can execute, for example, a “Paint All mode” in which at least a portion of a plurality of items are replaced with items of a common variation. The user operates the cursor C to specify a plurality of wall items W1 and W3, which are items of a common type TP1 (e.g., “wooden wall”) in a virtual house H. The user then selects wall items of a common variation VR1 (e.g., items of the “wooden wall” type in “orange” color) associated with the plurality of wall items W1 and W3, and presses the “change” button B. In this example, the item replacement unit 54 replaces at least a portion of the plurality of items W1 and W3 forming the virtual house H with items of the common variation VR1 (step S27).

More precisely, the virtual house H has four wall surfaces, i.e., it does not only have the wall items W1 and W3 but also has wall items (which are, for example, of the common type) corresponding to the wall items W1 and W3, respectively (although such wall items are not shown in FIG. 14). Thus, in the above-described “Paint All mode,” these four wall items can be painted (replaced) all together. This configuration enables a plurality of items satisfying a predetermined condition to be easily replaced regardless of the user's virtual viewpoint (even if the items are not visible to the user in the virtual space). It should be noted that if the walls that are invisible in the virtual space are of a different type (e.g., an iron wall) from the wall items W1 and W3, such walls are not replaced because they do not satisfy the predetermined condition.

In the example of FIG. 14, the wall items W1 and W3 include portions with openings, and such portions correspond to the windows or doors through which the inside of the virtual house H can be seen. Here, since the wall items W1 and W3 are targets for replacement, a selected effect is added (displayed) to these wall items, as compared to other portions, and such selected effect is also added, just for the sake of convenience, to the window portions and door portions of the wall items W1 and W3 (and the visible inside of the virtual house H). However, even when all of the four walls, including the wall items W1 and W3, are replaced in the “Paint All mode,” the replacement processing (such as color change) would obviously not be performed for the visible inside of the virtual house H.

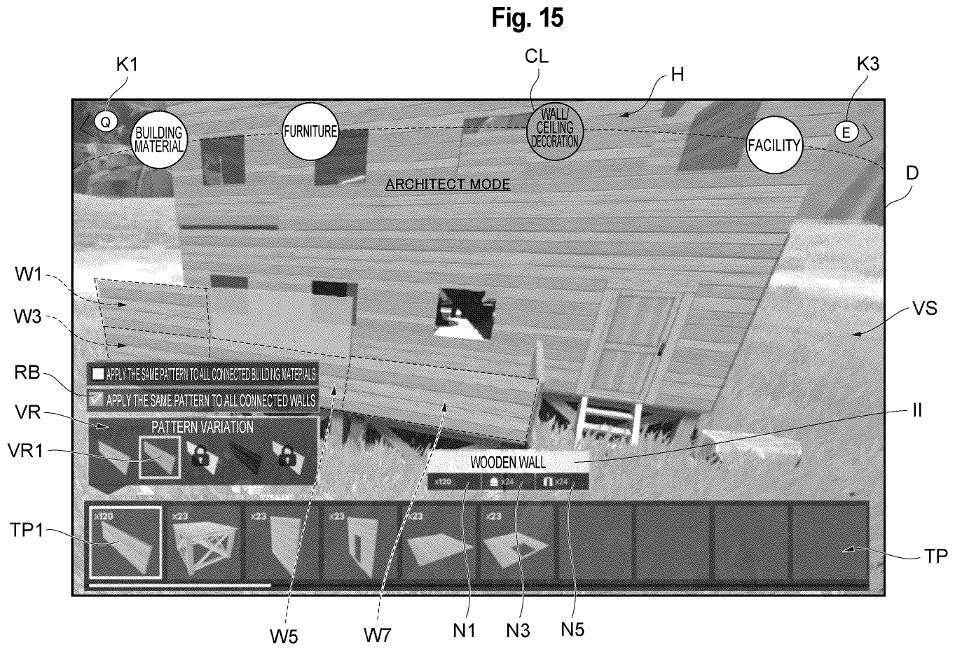

FIG. 15 is a diagram showing another example of the “Paint All mode” performed in the virtual space VS. In FIG. 15, items of one or more variations VR related to a particular item of type TP1 are first presented on the screen D in a manner whereby a variation item can be specified. After that, when the user specifies a particular variation item VR1 (e.g., an item of the “wooden wall” type in the “wall/ceiling decoration” category in orange color) and the user also selects, for example, a radio button RB for “applying the same pattern to all connected walls,” a plurality of connected wall items W1, W3, W5 and W7 in the virtual house H may be replaced with wall items of the common variation VR1.

According to the second example of the present embodiment, the information processing system 100 can simultaneously replace a plurality of items forming one or more virtual structures all at once with items of a common variation. Accordingly, the present embodiment improves convenience regarding the user's operation for a virtual structure in the virtual space. More specifically, the present embodiment improves the user's convenience when changing the virtual structure (e.g., painting work).

### Third Example: Region Output Processing

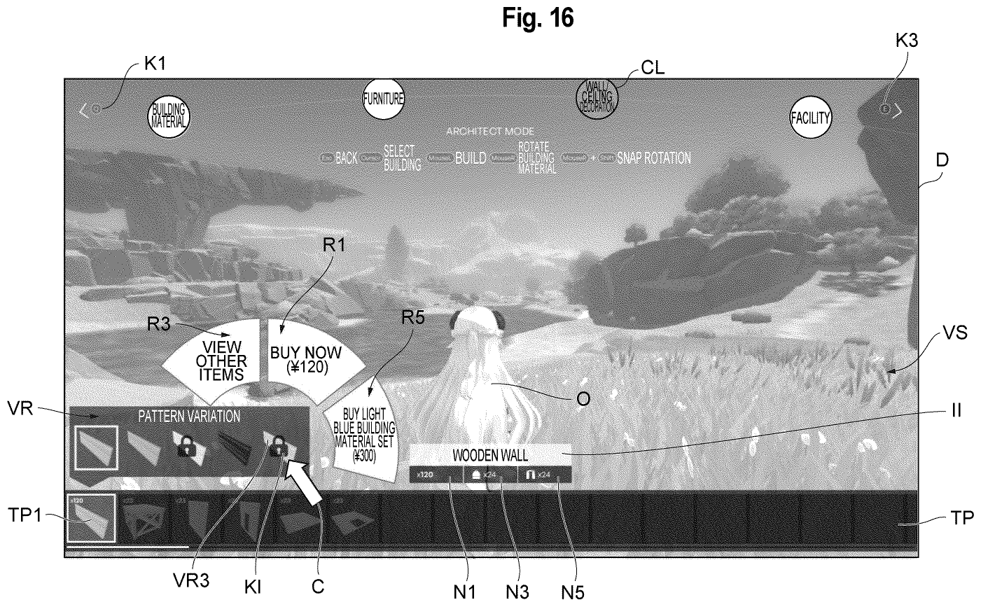

Region output processing according to a third example of the first embodiment of the present invention will now be described with reference to FIG. 16. As shown in FIG. 16, the region outputting unit 46 shown in FIG. 3 outputs, for example, an input receiving region R1 on the screen D for receiving a user input for the user to purchase (acquire) at least a first variation item VR3 (e.g., a light blue wooden wall), which is not possessed by the user, when the first variation item VR3 is specified based on a user input from among items of a plurality of variations VR for the item of the particular type TP1. Here, “a first variation item VR3 not possessed by the user being specified” includes, for example, the user operating the cursor C on the screen D to click on the icon of the first variation item VR3. When the user operates the cursor C to, for example, press the input receiving region R1, the user (object O) can purchase the first variation item VR3.

When the first variation item VR3 not possessed by the user is specified, the region outputting unit 46 outputs a plurality of input receiving regions R1, R3, and R5 at positions corresponding to the position where the first variation item VR3 is presented on the screen D. For example, the region outputting unit 46 may output the plurality of input receiving regions R1, R3, and R5 in association with the position where the first variation item VR3 is presented on the screen D. The region outputting unit 46 may output the plurality of input receiving regions R1, R3, and R5 at positions corresponding to the position where the first variation item VR3 is presented on the screen D and in a manner such that a predetermined shape is formed by the input receiving regions R1, R3, and R5 on the screen D (e.g., in a shape that surrounds the first variation item VR3). The predetermined shape may be a given shape and may include shapes other than the above-mentioned shape.

When the screen D is a touch panel screen, “a first variation item VR3 not possessed by the user being specified” includes, for example, the user touching the icon of the first variation item VR3 with their finger and maintaining the state for a certain period of time (i.e., pressing and holding the icon). In the state where the plurality of input receiving regions R1, R3, and R5 are displayed on the screen D, the user taps (selects) any of the regions with their finger, and as a result, processing corresponding to the tapped region is executed.

The plurality of input receiving regions includes an input receiving region R5 for purchasing (acquiring) the first variation item VR3 not possessed by the user (e.g., a light blue wooden wall) and an item that is of the same variation as, but of a different type from, the first variation item VR3, as a set of items. For example, the input receiving region R5 may receive an input to purchase a set of a light blue wooden wall item, a light blue ceiling item, and a light blue door item.

In purchasing, for example, a set of light blue items, if the user already possesses a particular type of light blue item from among the items in the set, a dialog may be displayed on the screen for such particular type of light blue item, stating, for example, that “You already possess a light blue XXX item. Would you like to buy this set?” This configuration can warn the user that the set of items the user is going to purchase includes an item that the user already possesses.

According to the third example of the present embodiment, the information processing system 100 outputs variation items not possessed by the user in a predetermined region on the screen D, and the user can purchase such variation item not possessed by the user by simply specifying the region (without moving to another screen for purchase of items which is different from the screen D). Accordingly, the present embodiment improves the user's convenience when the user purchases variation items not possessed by the user. More specifically, the crafting game of the present embodiment is implemented with item purchase modes prepared for the purchase of each type of item and further for the purchase of each variation of each type of item. In other words, the information processing system 100 has the feature of performing the item purchase processing in a manner so as to allow the user to purchase a desired item in response to the user's operation. If the user, who is in the process of performing crafting work, needs to display another screen for an item purchase mode which is different from the screen D, the user's crafting work would be interrupted. Enabling the user to purchase variation items through a simple operation of moving the cursor on the same screen or moving their finger on the same screen improves the user's convenience when purchasing items. Furthermore, the user is not only permitted to purchase a variation, but can also perform various other operations, such as purchasing variations in a set, and this provides a further improvement of the user's convenience when purchasing items.

As shown in the example of FIG. 16, users can purchase items using the legal tender they possess (e.g., Japanese yen). However, any method may be used for purchasing items. For example, users may purchase in-game currency (e.g., coins or stones) that can be used in the game in advance with legal tender and use the in-game currency to purchase items. The information processing system 100 may be configured so as to allow for the purchase of items with currency other than legal tender, such as virtual currency.

### Fourth Example: Virtual Structure Movement Processing

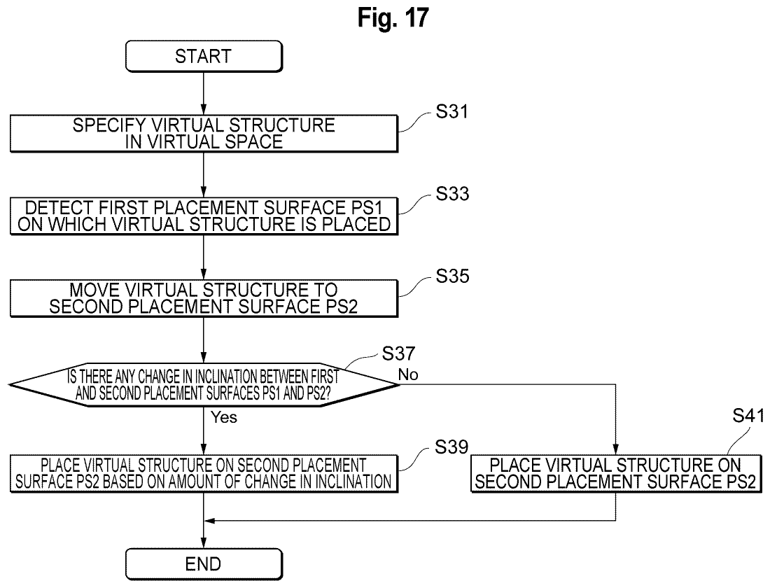

Virtual structure movement processing according to a fourth example of the first embodiment of the present invention will now be described with reference to FIGS. 17 to 19. FIG. 17 is a flowchart showing an example of the virtual structure movement processing according to the first embodiment of the present invention.

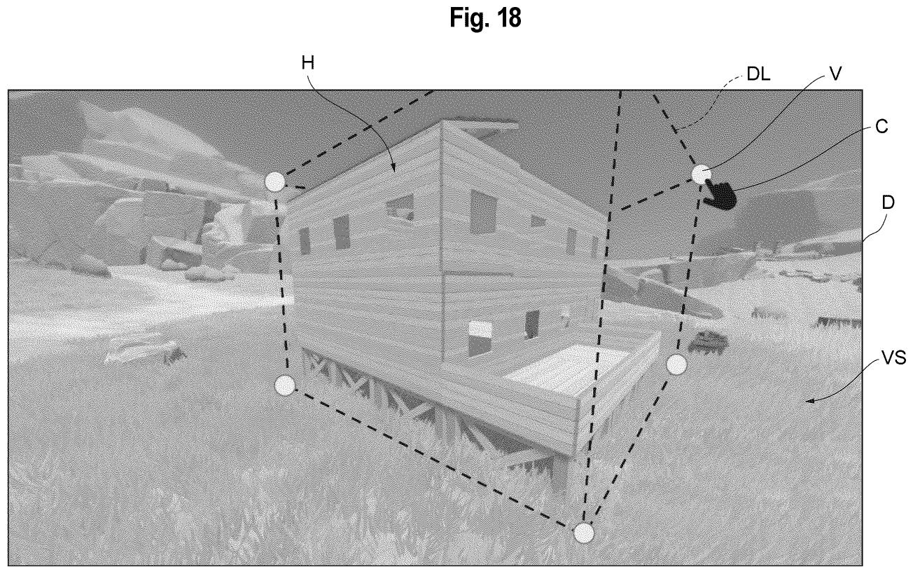

As shown in FIG. 17, the information processing system 100 specifies a virtual structure in the virtual space VS as a movement target (step S31). As shown in FIG. 18, based on a user input made through the operation of the cursor C, the movement unit 57 of the information processing system 100 shown in FIG. 3 defines a predetermined range surrounded by a plurality of dashed lines DL connecting each of a plurality of vertices V. The virtual house H included in the predetermined range is specified as a virtual structure to be moved. Any number of virtual structures to be moved may be specified, and a single virtual structure or two or more virtual structures may be a movement target.

Next, as shown in FIGS. 18 and 19, the movement unit 57 detects a first placement surface PS1, which is the source of movement on which the virtual house H is placed (step S33). The movement unit 57 starts performing processing to move the virtual house H to a second placement surface PS2, which is the movement destination (step S35). The movement unit 57 detects the second placement surface PS2. The movement unit 57 determines whether or not there is a change in inclination between the first placement surface PS1 and the second placement surface PS2 (step S37).

If there is no change in inclination between the first and second placement surfaces PS1 and PS2 (No in step S37), the processing goes to step S41. The movement unit 57 places the virtual house H on the second placement surface PS2 (step S41). On the other hand, if there is a change in inclination between the first and second placement surfaces PS1 and PS2 (Yes in step S37), the processing goes to step S39. Based on an amount of change in inclination between the first and second placement surfaces PS1 and PS2 (e.g., an angle α shown in FIG. 19), the movement unit 57 adds a base portion BS3 to the base portion BS1 of the virtual house, and then places the virtual house H on the second placement surface PS2 (step S39).

According to the fourth example of the present embodiment, when one or more virtual structures are moved from a first placement surface on which the virtual structures are placed in the virtual space VS to a second placement surface having a different inclination from the first placement surface, the information processing system 100 places the one or more virtual structures on the second placement surface based on the inclination. Accordingly, even when moving a virtual structure from one placement surface to another having a different inclination, the information processing system 100 can properly place the virtual structure in accordance with the inclination of the destination placement surface.

Regarding step S39, if the user does not possess an item of a member corresponding to the base portion BS3 to be added to the base portion BS1, the movement unit 57 may be configured so as not to allow placement of the virtual structure on the second placement surface PS2. In this case, the movement unit 57 may alarm the user on the screen, stating that placement of the virtual structure on the second placement surface PS2 is not allowed.

Additionally, the movement unit 57 may use an item of a base member whose shape can be varied according to the shape (topography) of the second placement surface PS2. Such base member items with a variable shape include, for example, items related to a pillar of a raised floor, and such items may be controlled so as to automatically extend up and down according to the shape of the second placement surface PS2.

### Second Embodiment

In the second embodiment, the crafting game is managed by the player terminal 3 and, in this respect, it differs from the first embodiment in which the crafting game is managed by the information processing server 1. The second embodiment will now be described by focusing on the difference from the first embodiment.

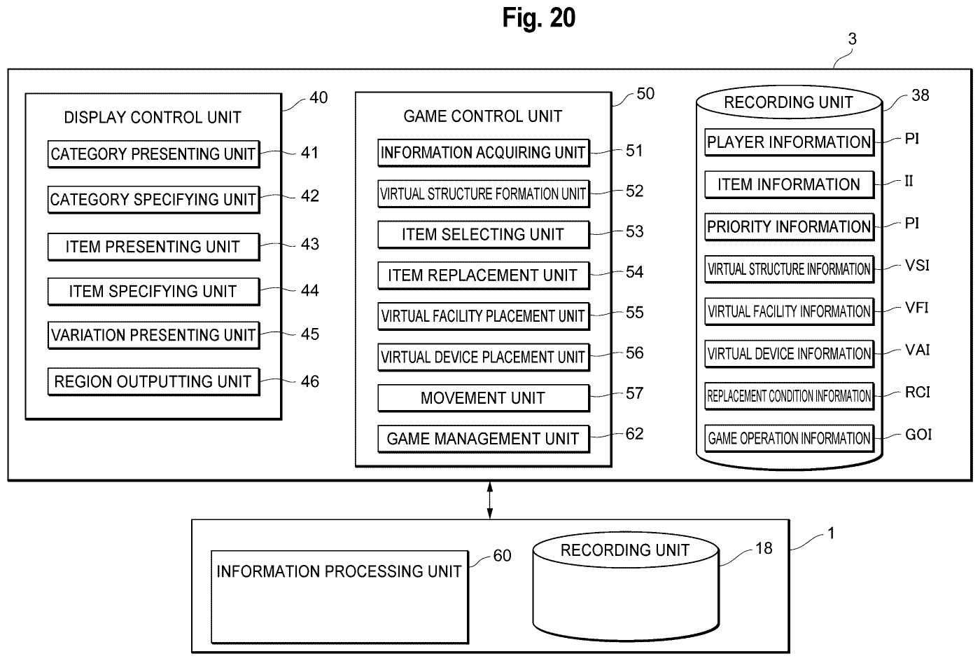

FIG. 20 is a schematic configuration diagram (block diagram) showing an example of the functional configuration of the information processing server and player terminal according to the second embodiment of the present invention. The crafting control unit 50 of the player terminal 3 further includes a game management unit 62. The recording unit 38 further records game operation information GOI.

While the crafting control unit 50 of the player terminal 3 shown in FIG. 3 does not have a game management unit 62, the player terminal 3 shown in FIG. 20 is configured such that the crafting control unit 50 further includes, in terms of function, a game management unit 62 as described above. The reasons for this are as follows: if the information processing server 1 has such configuration, it becomes necessary for the information processing server 1 to transmit data related to the crafting game to the player terminal 3 at high frequency, which causes an enormous amount of communication being made between the information processing server 1 and the player terminal 3. In order to reduce such amount of communication, the player terminal 3 is configured so as to include the above-noted configuration.

When each of the functions is concentrated on the player terminal 3, such configuration can increase the risk of a player conducting fraudulent acts, such as tampering with various game media, various parameters, etc., at the player terminal 3. However, since the latest updated information is managed by the information processing server 1, it is possible to examine the presence/absence of any fraudulent acts through constant comparison to the information managed by the information processing server 1, and to accordingly prevent an occurrence of fraudulent acts.

### Third Embodiment

The third embodiment differs from the first embodiment in that each of the configurations provided in the display control unit and crafting control unit of the player terminal in the first embodiment is provided in the information processing unit of the information processing server. The third embodiment will now be described by focusing on the difference from the first embodiment.

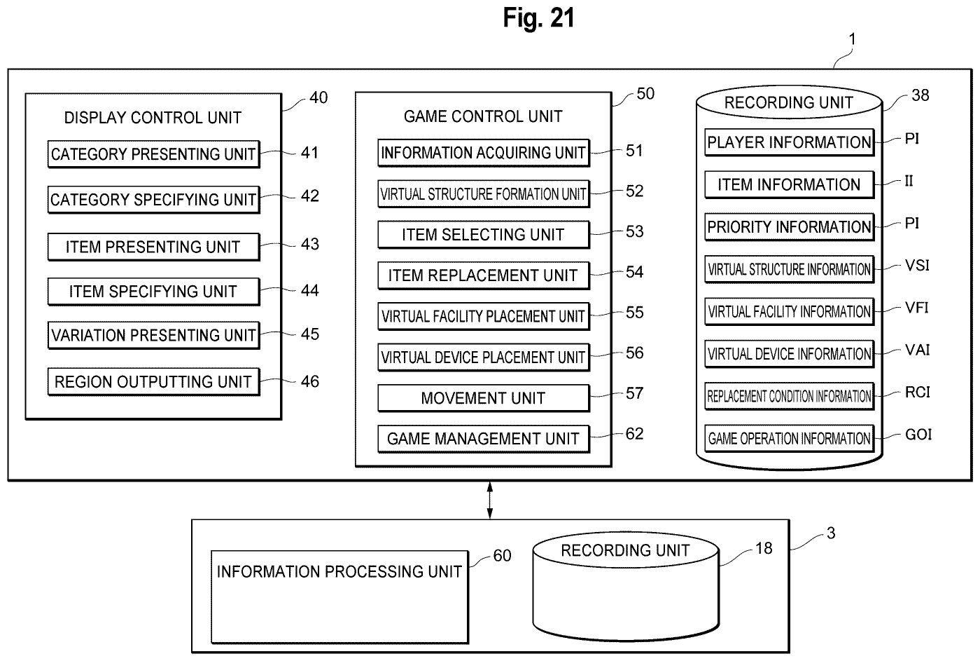

FIG. 21 is a schematic configuration diagram (block diagram) showing an example of the functional configuration of the information processing server and player terminal according to the third embodiment of the present invention. The information processing server 1 comprises, in terms of function, each of the configurations provided in the display control unit 40 and the crafting control unit 50 of the player terminal 3 in the second embodiment (FIG. 20).

According to the third embodiment, each function is concentrated on the information processing server 1, so that it is possible to prevent a player from conducting fraudulent acts, such as tampering with information related to the game, including various parameters of the game, using the player terminal 3.

FIG. 22 is a block diagram showing the hardware configuration of the information processing server 1 and the hardware configuration of the player terminal 3 according to an embodiment of the present invention. In the drawing, reference signs for the hardware of the information processing server 1 are written without parentheses, while reference signs for the hardware of the player terminal 3 are written with parentheses.

In an example, the player terminal 3 includes a CPU (Central Processing Unit) 11, a memory 33 including, for example, a ROM (Read Only Memory) and a RAM (Random Access Memory), a bus 34, an input/output interface 35, an input unit 36, an output unit 37, a recording unit 38, and a communication unit 39.

The CPU 31 executes various types of processing according to programs recorded in the memory 33 or programs loaded from the recording unit 38 into the memory 33.

The memory 33 also appropriately stores, for example, necessary data for the CPU 31 to execute various types of processing. The CPU 31 and the memory 33 are connected to each other via the bus 34. The input/output interface 35 is also connected to the bus 34. The input/output interface 35 is also connected to the input unit 36, the output unit 37, the recording unit 38, and the communication unit 39.

The input unit 36 is comprised of various buttons, a touch panel, or a microphone, etc., and inputs various types of information in response to instructing operations by an administrator, etc. of the information processing server 1. The input unit 36 may be implemented by an input device, such as a keyboard or a mouse, which is separate from a main body that houses other units of the information processing server 1.

The output unit 37 is comprised of a display and a speaker, etc., and outputs image data and music data. The image data and music data output by the output unit 37 are output through such display, speaker, etc. in a manner such that the player can recognize them as images and music.

The recording unit 38 is comprised of a semiconductor memory, such as a DRAM (Dynamic Random Access Memory), and stores various types of data.

The communication unit 39 realizes communications to be made with other devices. For example, the communication unit 39 communicates with the information processing server 1 via the network N.

The player terminal 3 is appropriately provided, as needed, with a drive (although such drive is not shown in the drawing). Such drive is appropriately equipped with removable media comprising, for example, a magnetic disk, an optical disk, a magneto-optical disk, or a semiconductor memory. The removable media store programs for execution of a game and various data including image data. Programs read from the removable media by the drive and various data, including image data, are installed on the recording unit 38 as needed.

The hardware configuration of the information processing server 1 will be described next. In an example, the information processing server 1 includes a CPU 11, a memory 13, a bus 14, an input/output interface 15, an input unit 16, an output unit 17, a recording unit 18, and a communication unit 19. Each of these units has the same functions as the above-described unit of the player terminal 3 having the same name with a different reference sign. Accordingly, any redundant explanations for these units will be omitted here.

It should be noted that each of the embodiments and examples described above are provided merely for facilitating understanding of the invention, and should not be construed as limiting the invention. The present invention may be modified/improved without departing from the spirit of the invention, and such equivalents should also be included in the scope of the present invention. Furthermore, in the present invention, various disclosures may be formed by appropriately combining a plurality of components disclosed in each embodiment. For example, among the whole components constituting one embodiment, some components may be omitted. Further, components of an embodiment may be combined as appropriate with a different embodiment.

Part or all of the above-described embodiments may also be described as, but are not limited to, the following appendices:

### APPENDIX 1

A program for causing a computer providing a virtual space to function as:
a category presenting unit that presents, on a screen, one or more categories related to one or more items used by an object in the virtual space in a manner whereby a category can be specified;
a category specifying unit that specifies a particular category from among the categories, based on a user input;
an item presenting unit that presents, on the screen, one or more items associated with the specified particular category in a manner whereby an item can be specified;
an item specifying unit that specifies a particular item from among the one or more items, based on a user input; and
a variation presenting unit that presents one or more variation items for the specified particular item on the screen in association with the particular item in a manner whereby a variation item can be specified.

### APPENDIX 2

The program according to Appendix 1, wherein the item presenting unit presents the one or more items associated with the specified particular category according to a predetermined level of priority.

### APPENDIX 3

The program according to Appendix 1 or 2, wherein the predetermined level of priority is determined based on information which is at least one of: identification information of the items; a status of possession of the one or more items by the object; and a status of use of the one or more items by the object.

### APPENDIX 4

The program according to Appendix 3, wherein the status of use of the one or more items includes the one or more items having been used a predetermined threshold number of times or more, or at a predetermined threshold frequency or more, for an item that was most recently used by the object.

### APPENDIX 5

The program according to any one of Appendices 1-4, wherein the variation presenting unit presents, from among a plurality of variation items for the particular item, a first variation item and a second variation item in different forms, wherein the first variation item is possessed by the user and the second variation item is not possessed by the user.

### APPENDIX 6

The program according to any one of Appendices 1-5, further causing the computer to function as:
a region outputting unit that outputs, on the screen, an input receiving region for receiving a user input for the user to at least acquire a first variation item not possessed by the user from among a plurality of variation items for the particular item, when the first variation item is specified based on a user input.

### APPENDIX 7

The program according to Appendix 6, wherein the region outputting unit outputs the input receiving region at a position corresponding to a position where the first variation item is presented on the screen.

### APPENDIX 8

The program according to Appendix 6 or 7, wherein, when the input receiving region includes a plurality of the input receiving regions, the region outputting unit outputs the plurality of input receiving regions at positions corresponding to a position where the first variation item is presented on the screen and in a manner such that a predetermined shape is formed by the plurality of input receiving regions.

### APPENDIX 9

The program according to any one of Appendices 6 to 8, wherein, when the input receiving region includes a plurality of the input receiving regions, the plurality of input receiving regions includes an input receiving region for acquiring the first variation item and an item of the same variation as, and of a different type from, the first variation item.

### APPENDIX 10

The program according to any one of Appendices 1 to 9, wherein, after presenting the one or more items associated with the specified particular category on the screen in a manner whereby an item can be specified, the item presenting unit presents the number of the specified particular items that the user possesses, in association with the particular item.

### APPENDIX 11

A virtual space providing method implemented by a computer providing a virtual space, the method comprising the steps of:
presenting, on a screen, one or more categories related to one or more items used by an object in the virtual space in a manner whereby a category can be specified;
specifying a particular category from among the categories, based on a user input;
presenting, on the screen, one or more items associated with the specified particular category in a manner whereby an item can be specified;
specifying a particular item from among the one or more items, based on a user input; and
presenting one or more variation items for the specified particular item on the screen in association with the particular item in a manner whereby a variation item can be specified.

### APPENDIX 12

A virtual space providing system for providing a virtual space, the system comprising:
a category presenting unit that presents, on a screen, one or more categories related to one or more items used by an object in the virtual space in a manner whereby a category can be specified;
a category specifying unit that specifies a particular category from among the categories, based on a user input;
an item presenting unit that presents, on the screen, one or more items associated with the specified particular category in a manner whereby an item can be specified;
an item specifying unit that specifies a particular item from among the one or more items, based on a user input; and
a variation presenting unit that presents one or more variation items for the specified particular item on the screen in association with the particular item in a manner whereby a variation item can be specified.

### REFERENCE SIGNS LIST

1 . . . Information processing server; 3 . . . player terminal, 11(31) . . . CPU; 13(33) . . . memory; 14(34) . . . bus; 15(35) . . . input/output interface; 16(36) . . . input unit; 17(37) . . . output unit; 18(38) . . . recording unit; 19(39) . . . communication unit; 40 . . . display control unit; 41 . . . category presenting unit; 42 . . . category specifying unit; 43 . . . item presenting unit; 44 . . . item specifying unit; 45 . . . variation presenting unit; 46 . . . region outputting unit; 50 . . . game control unit; 51 . . . information acquiring unit; 52 . . . virtual structure formation unit; 53 . . . item selecting unit; 54 . . . item replacement unit; 55 . . . virtual facility placement unit; 56 . . . virtual device placement unit; 57 . . . movement unit; 60 . . . information processing unit; and 62 . . . game management unit

1. A non-transitory computer readable medium for causing a computer providing a virtual space to function as:
an acquiring unit that acquires item information regarding a plurality of items used by an object operated by a user in the virtual space;
a formation unit that forms one or more virtual structures based on the plurality of items;
a selecting unit that selects items of a common variation associated with the plurality of items, based on a user input; and
a replacement unit that replaces at least a portion of the plurality of items forming the one or more virtual structures with items of the common variation, when the plurality of items satisfy a predetermined condition.

2. The non-transitory computer readable medium according to claim 1, wherein the predetermined condition includes the plurality of items forming the one or more virtual structures being items of a common type.

3. The non-transitory computer readable medium according to claim 1, wherein the predetermined condition includes the plurality of items forming the one or more virtual structures being items of a common type and arranged adjacent to each other in the virtual space.

4. The non-transitory computer readable medium according to claim 1, wherein the predetermined condition includes the plurality of items forming the one or more virtual structures being items of a common type and placed in a predetermined range of the virtual space specified by the user.

5. The non-transitory computer readable medium according to claim 1, wherein the predetermined condition includes the plurality of items forming the one or more virtual structures being items of a common type and forming a single virtual structure placed in the virtual space that is specified by the user.

6. The non-transitory computer readable medium according to claim 1, further comprising causing the computer to function as a virtual facility placement unit that places a virtual storage facility in the virtual space, the virtual storage facility being capable of storing the plurality of items therein.

7. The non-transitory computer readable medium according to claim 1, further comprising causing the computer to function as a virtual device placement unit that places a virtual device in the virtual space, the virtual device providing a predetermined effect in a predetermined range of the virtual space based on the virtual device itself as a reference.

8. The non-transitory computer readable medium according to claim 7, wherein, when the virtual storage facility is placed in the predetermined range and the user is staying in the predetermined range, the formation unit acquires the one or more items from the virtual storage facility, based on a user input, and forms the one or more virtual structures with the acquired one or more items.

9. The non-transitory computer readable medium according to claim 7, wherein the predetermined effect includes a state in which a particular virtual structure from among the one or more virtual structures can be placed in the predetermined range.

10. The non-transitory computer readable medium according to claim 7, wherein the predetermined effect includes a state in which an object different from the object operated by the user does not appear in the predetermined range.

11. The non-transitory computer readable medium according to claim 7, wherein the virtual device includes a plurality of the virtual devices, each being displayed in a different form in the virtual space, and wherein the predetermined range associated with each of the plurality of the virtual devices is set according to the form in which the virtual device is displayed.

12. The non-transitory computer readable medium according to claim 1, further comprising causing the computer to function as a movement unit that moves the one or more virtual structures that are specified based on a user input,
wherein, when the movement unit moves the one or more virtual structures from a first placement surface on which the one or more virtual structures are placed in the virtual space to a second placement surface having a different inclination from the first placement surface, the movement unit places the one or more virtual structures on the second placement surface based on the inclination.

13. A virtual space providing method implemented by a computer providing a virtual space, the method comprising the steps of:
acquiring item information regarding a plurality of items used by an object operated by a user in the virtual space;
forming one or more virtual structures based on the plurality of items;
selecting items of a common variation associated with the plurality of items, based on a user input; and
replacing at least a portion of the plurality of items forming the one or more virtual structures with items of the common variation, when the plurality of items satisfy a predetermined condition.

14. A virtual space providing system for providing a virtual space, comprising:
an acquiring unit that acquires item information regarding a plurality of items used by an object operated by a user in the virtual space;
a formation unit that forms one or more virtual structures based on the plurality of items;
a selecting unit that selects items of a common variation associated with the plurality of items, based on a user input; and
a replacement unit that replaces at least a portion of the plurality of items forming the one or more virtual structures with items of the common variation, when the plurality of items satisfy a predetermined condition.
